(19) United States
(12) Patent Application Publication
(10) Pub. No.: US 2025/0061774 A1
(43) Pub. Date: Feb. 20, 2025

(54) METHOD, DEVICE AND COMPUTER PROGRAM FOR THE DEMATERIALIZATION OF GAME RECEIPTS

(71) Applicant: FDJ GAMING SOLUTIONS FRANCE, BOULOGNE-BILLANCOURT (FR)

(72) Inventor: Eric MEYNIEUX, VENTABREN (FR)

(21) Appl. No.: 18/721,690

(22) PCT Filed: Dec. 15, 2022
(86) PCT No.: PCT/FR2022/052363

§ 371 Date: Jun. 19, 2024

(30) Foreign Application Priority Data
Dec. 20, 2021 (FR) 2113986

(51) Int. Cl. G07F 17/32; G06Q 20/32

(52) U.S. Cl. CPC G07F 17/3244; G06Q 20/3274

(57) ABSTRACT

A method for dematerialization of game receipts. After creating an electronic vault and associating the created electronic vault with a personal device of a player, at least one electronic coupon is recorded in the electronic vault, upon request from the personal device of the player. The electronic coupon includes data of a bet to be placed on a game managed by a game engine. Then, according to a list of at least one electronic coupon recorded in the electronic vault, at least one bet is placed with at least one game engine. An electronic receipt is then received from each game engine with which a bet has been placed, confirming the placement of the bet and recording of the electronic receipt in the electronic vault.

The invention relates to the field of games, such as drawing games and sports bets, and to the dematerialization of participation in such games for players who do not wish to use a player account.

In the field of gambling, in particular drawing games and sports bets, it is possible to distinguish two modalities for access to a game, depending on the regulations in force and the procedures of the game operator.

In a modality that involves a player account, the player should, prior to any bet, create a player account by transmitting personal data and by proving his/her identity. These elements are certified by the lottery and the player should authenticate and log in at each access to the account. The player accounts are very often associated with payment means or electronic wallets via which the bets are drawn and the possible gains automatically paid.

In a modality that does not involve a player account, the player is not required to register and prove his/her identity when he/she purchases a participation to the game. However, the lottery could ask him/her to provide some personal information that will be checked upon payment of possible wins.

Participation to a drawing game or to a sports bet may be proposed at the point-of-sale or online. Online participation requires a player account while point-of-sale participation may be performed according to either one of the previously-described two modalities for access to the set, access without a player account being today very common.

When he/she plays at a point-of-sale without passing through a player account, the player selects a game formula and possibly one or more combination(s) on which he/she wishes to participate, and then transmits it to the retailer, in paper form, by filling a game bulletin (also called a game coupon) or verbally. The retailer collects the amount of the bet and records the game participation of the player. Alternatively, the player could directly enter and pay his/her game participation on a self-service terminal of the point-of-sale. Following recording of the game participation, a receipt is submitted to the player, generally in paper form, as a proof of play. Subsequently, in case of winning, the receipt enables the player to justify his/her participation and to obtain the payment of the win at the point-of-sale.

This method has the drawback of requiring printing of game receipts. This printing generates significant costs, financially and ecologically.

Hence, there is a need for dematerialization of the game receipts, for players wishing to play at the point-of-sale without creating a player account. A solution for dematerializing the game receipts should be as independent as possible from the game engines in order to reduce the development and integration costs.

In particular, the present invention aims to solve these problems.

### DISCLOSURE OF THE INVENTION

To this end, the invention provides a method for dematerializing game receipts, comprising the following steps, implemented by a game receipt dematerialization module:
creating an electronic vault and associating the created electronic vault with a personal device of a player;
recording at least one electronic coupon in the electronic vault, upon request from the personal device of the player, an electronic coupon comprising data of a bet to be placed on a game managed by a game engine;
according to a list of at least one electronic coupon recorded in the electronic vault, placing at least one bet with at least one game engine; and
receiving, from each game engine with which a bet has been placed, a message confirming the placement of said bet and recording an electronic receipt in the electronic vault.

Thus, the method according to the invention allows considerably reducing the costs and the ecological impact related to receipt printing, without imposing the creation of a player account or the transmission of personal and/or banking data, while offering a high security level with regards to a risk of loss of receipt or payments of wins to beneficiaries who would not be the winners. The method according to the invention also offers means for the operators of games to offer complementary services. Moreover, the method according to the invention allows acquiring information relating to the practice of the game by the players, while preserving their anonymity, allowing preventing an addiction, for example.

According to particular embodiments, the dematerialization method further comprises the following steps, implemented by the dematerialization module:
obtaining, from each game engine associated with each electronic receipt recorded in the electronic vault, win data associated with the electronic receipt;
in case of winning, transmitting the win data to a point-of-sale application;
receiving a confirmation from the point-of-sale application; and
obtaining payment of the win from the game engine.

Still according to particular embodiments, the dematerialization method further comprises the following steps, implemented by the dematerialization module:
managing a status associated with each stored electronic receipt; and
in case of winning, changing the corresponding status.

Still according to particular embodiments, the dematerialization method further comprises the following steps, implemented by the dematerialization module:
in case of winning, generating a temporary payment code;
transmitting the generated temporary payment code to the personal device, the temporary payment code comprising the win data; and
receiving a request to change said status from the point-of-sale application.

Still according to particular embodiments, each electronic receipt is recorded in the electronic vault in association with an electronic vault access code associated with the personal device of the player.

Still according to particular embodiments, each electronic coupon is recorded in the electronic vault in association with the electronic vault access code associated with the personal device of the player.

Still according to particular embodiments, the dematerialization method further comprises the following steps, implemented by the dematerialization module:
generating the electronic vault access code in response to a request for activation received from a point-of-sale application; and
transmitting the electronic vault access code to the personal device.

Still according to particular embodiments, the dematerialization method further comprising a step of displaying the electronic vault access code, for example in the form of a QR code, implemented by the personal device, said electronic vault access code allowing reading thereof by a point-of-sale application.

The present invention also relates to a dematerialization module configured to implement the previously-described method as well as a gaming system, comprising a dematerialization module and a personal device of a player, configured to implement the previously-described method.

The present invention also relates to a computer program including instructions for implementing the previously-described method, or some portions of this method, when this program is executed by a computer.

This program can use any programming language (for example, an object language inter alia) and be in the form of an interpretable source code, a partially-compiled code or a fully-compiled code.

Another aspect relates to a non-transitory medium for storing a computer-executable program, comprising a data set representing one or more program(s), said one or more program(s) comprising instructions executing all or part of the above-described method, upon execution of said one or more program(s) by a computer comprising a processing unit operatively coupled to memory means and to an input/output interface module.

### BRIEF DESCRIPTION OF THE DRAWINGS

Other features, details and advantages of the invention will appear better upon reading the detailed description hereinafter. The latter is purely illustrative and should be read with reference to the appended drawings, wherein:

FIG. 1 illustrates an example of an environment in which the invention may be implemented according to particular embodiments;

FIG. 2 illustrates an example of a computer architecture in accordance with some particular embodiments of the invention;

FIGS. 3 and 4 illustrate examples of time charts of steps of the method of the invention according to particular embodiments; and

FIG. 5 illustrates an example of a device that could be used to implement, at least partially, embodiments of the invention, in particular steps described with reference to FIGS. 3 and 4.

### DETAILED DESCRIPTION

According to particular embodiments of the invention, the participation of a player to a game is electronically managed using an electronic bulletin (or e-bulletin), also called an electronic coupon (or e-coupon) used as a means for placing a bet on a game, and/or using an electronic receipt (or e-receipt) used as a credential for participation to the game and means for payment of wins, by implementing an electronic vault mechanism access to which is associated with a unique identifier independent of the identity of the player. Preferably, the management of the electronic vault is performed independently of the game engine.

More specifically, the invention enables in particular a player to activate an electronic vault, in a centralized vault management system, in order to obtain allocation thereof, independently of game engines, and to access thereto from a personal device such as a mobile phone. It also enables the player to record electronic coupons in the electronic vault allocated to him/her, place bets from the electronic coupons, for example by using his/her personal device in connection with a terminal of a point-of-sale, obtain an electronic receipt in response to a placement, follow the progress of his/her bets and request payment of wins, for example by using his/her personal device in connection with a terminal of a point-of-sale.

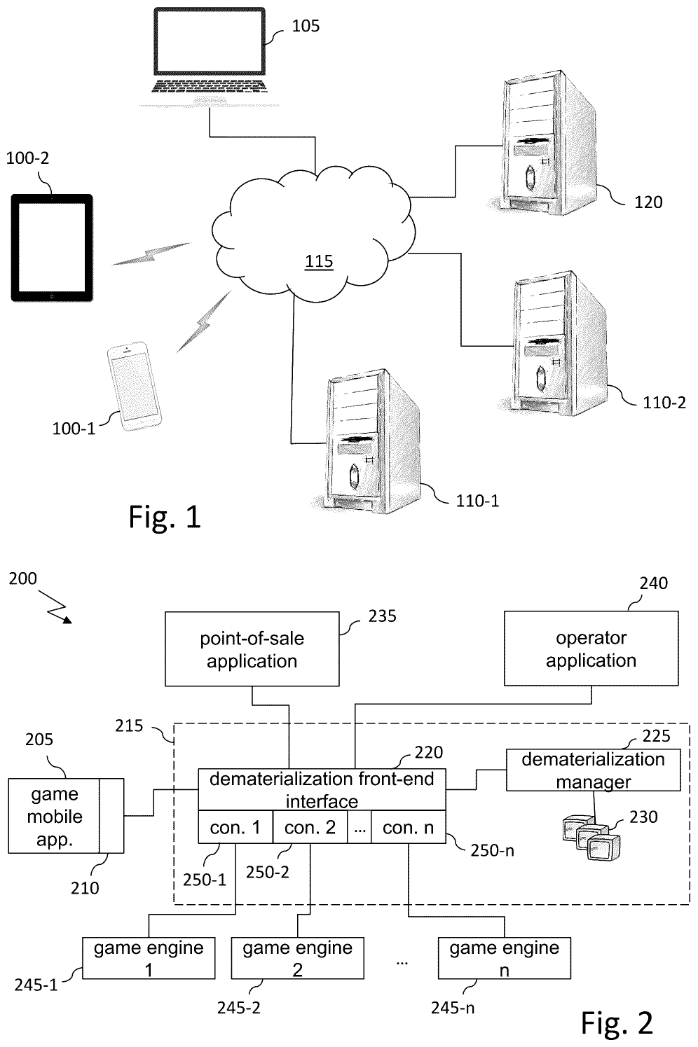

FIG. 1 illustrates an example of an environment in which the invention may be implemented according to particular embodiments. According to the illustrated example, a user may use a personal device such as a mobile phone (or smartphone) 100-1 or a tablet 100-2 to prepare and manage his/her participation to one or more game(s), for example, filling one or more game coupon(s) such as draw coupons and/or sports bet coupons. This personal device is provided with a communication interface, for example of the WiFi type (WiFi is a trademark) or of cellular type (for example 4G or 5G), enabling establishment of a connection with a communication network 115, for example the Internet. This device is further equipped, in one embodiment, with a local communication interface, for example an interface of the Bluetooth type (Bluetooth is a trademark) or NFC type (acronym for Near-Field Communication in Anglo-Saxon terminology), to exchange data with another mobile device, a computer or a terminal.

To participate to one or more game(s), the player should place (or record) his/her participation with the operator of the considered game(s), for example by using a terminal 105 of a point-of-sale. For example, the terminal 105 is a PC (Personal Computer) type computer or a tablet, comprising a communication interface, for example of the WiFi type or Ethernet type, enabling establishment of a connection with the communication network 115. Furthermore, in one embodiment, this terminal is equipped with a local communication interface, for example an interface of the Bluetooth or NFC type, to exchange data with a personal device of a player.

Recording of the participation of a player to games is notified to the concerned game engines, generally executed on independent servers, for example on the servers 110-1 and 110-2, herein through the communication network 115. For these purposes, the servers 110-1 and 110-2 comprise a communication interface, for example of the WiFi type or Ethernet type. Of course, several different game engines may be executed on the same server and the execution of the same game engine may be distributed over several servers.

According to particular embodiments, the game operators use modules for dematerializing game documents (by game documents, it should be understood game coupons and game receipts), preferably executed on independent servers, for example the server 120, which manages the relationships between game applications implemented on personal devices of player, terminals of points-of-sale and game engines. Like the servers 110-1 and 110-2, the server 120 is herein connected to the communication network 115, for example via a WiFi or Ethernet type communication interface.

The data exchanges between the personal devices of the players, the terminals of the points-of-sale, the game engines and the dematerialization modules are herein performed via the same communication network 115. Alternatively, several distinct communication networks may be used.

Of course, numerous variants may exist.

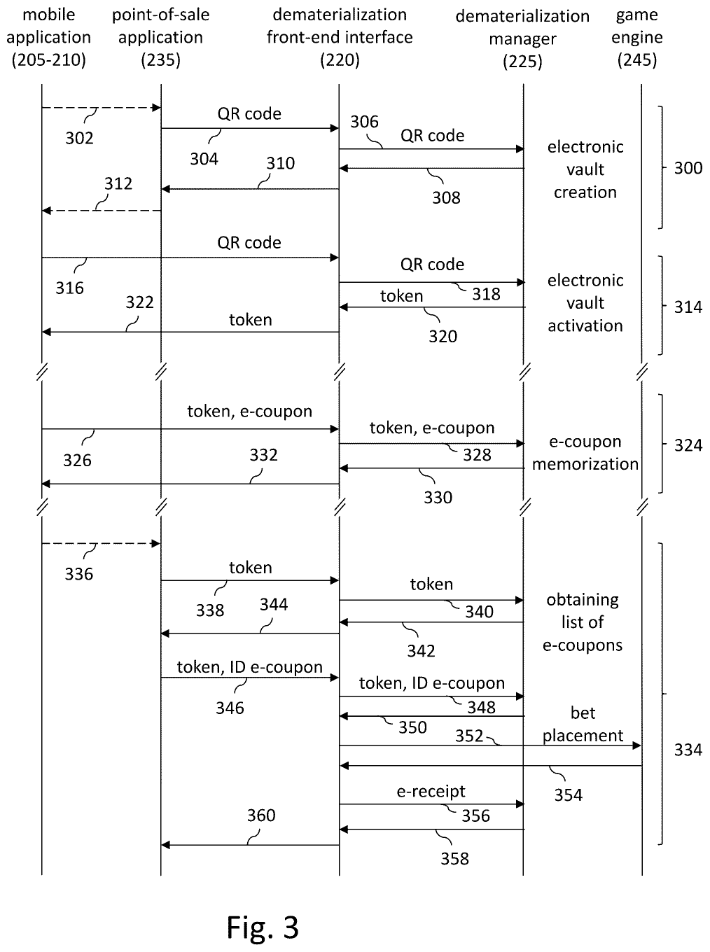

FIG. 2 illustrates an example of a computer architecture in accordance with some particular embodiments of the invention.

As illustrated, the computer architecture 200 comprises a game mobile application 205 associated with a dematerialization mobile interface 210 implemented on a personal device of a player, for example the device 100-1 or 100-2 of FIG. 1. The mobile application enables a player to prepare and record his/her participation to a game, for example, filling one or more game coupon(s) such as draw coupons or sports betting coupons. In particular, the dematerialization mobile interface 210 is intended to manage receipts of electronic games generated upon recording of a participation to a game. It is configured to interact with a dematerialization module 215 implemented in one or more server(s) of a game operator, for example the server 120 of FIG. 1. The dematerialization module 215 enables the player to activate an electronic vault in order to obtain the allocation thereof and to access it in order to manage his/her coupons and electronic receipts.

The dematerialization module 215 herein includes a dematerialization front-end interface 220, which is a front layer that further processes requests from the game mobile applications 205. The dematerialization module also includes a dematerialization manager 225, or dematerialized document manager, which herein consists of a back-office module 230 for managing electronic vaults, electronic coupons and electronic receipts (not shown).

As illustrated, the front-end interface 220 is herein connected to a point-of-sale application 235 (implemented in several points-of-sale), an operator application 240, the dematerialization manager 225 and game engines 245-1 to 245-n via connectors 250-1 to 250-n, respectively, belonging to the dematerialization module 215.

For example, the point-of-sale application 235 is implemented in the terminal 105 of FIG. 1. It comprises several access modules, for example one per point-of-sale, to access the dematerialization front-end interface. This application comprises functionalities intended in particular to allow proceeding with the placement of games such as draws and bets, with the management of these games and with the payment of wins, by enabling an interaction with a player personal device and with the dematerialization module.

According to some embodiments of the invention, the player can obtain the allocation of an electronic vault, access the electronic vault in order to create electronic coupons and select those on which he/she wants to bet to constitute a game participation basket. The operator application 240 enables the retailer to access the game participation basket, to record the game participations from the electronic coupons after validation of the payment of the basket by the player and to receive electronic receipts corresponding to these recorded game participations. Finally, the operator application 240 enables the player to obtain the total amount of payable wins borne by the electronic receipts of the electronic vault.

Each game engine or game module, generically referenced 245, herein uses a particular connector, generally referenced 250, to take account of the specificities of the considered game during the data exchange with the dematerialization front-end interface 220.

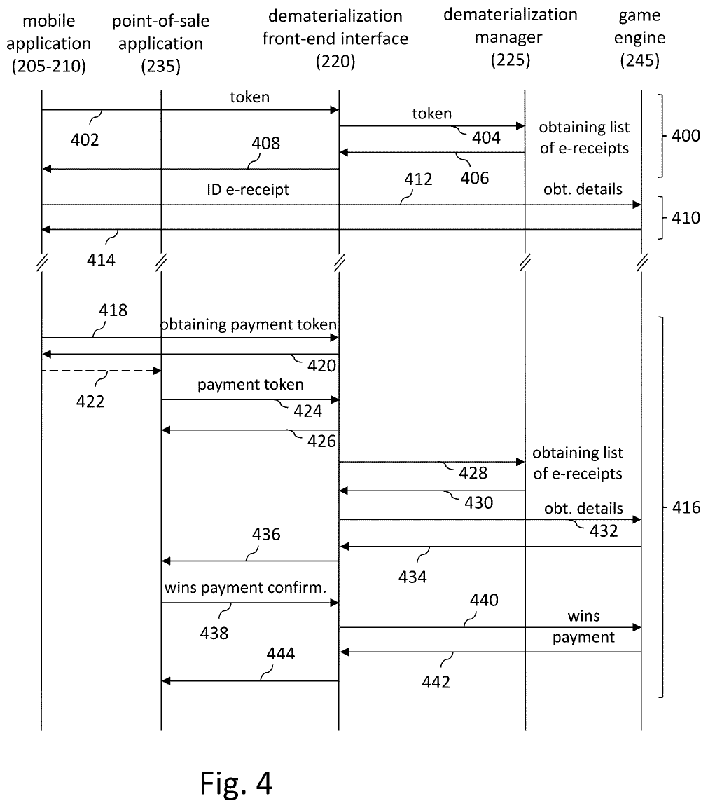

Examples of data exchanges between a game mobile application and a dematerialization mobile interface (together so-called the mobile application), a point-of-sale application, a dematerialization front-end interface, a dematerialization manager and game engines are described with reference to FIGS. 3 and 4.

FIGS. 3 and 4 illustrate examples of time charts of steps of the method of the invention according to particular embodiments.

As illustrated, a first set of steps 300 is intended to create an electronic vault using an electronic vault identification medium, for example a physical card. Such a medium is herein provided with a unique activation code, for example in the form of a QR code or a barcode, or any other information representation or coding. Electronic vault identification media may be distributed by a gaming operator to point-of-sale retailers to enable the creation of electronic vaults. According to the example illustrated in FIG. 3, a player wishing to play according to embodiments of the invention, for example to reduce the use of paper, asks a retailer (step 302), in a point-of-sale, to give him/her an electronic vault identification medium. The retailer takes such a medium in his/her stock, enters or scans the activation code of the medium, for example the code printed on the medium, and returns it to the player (step 312).

The QR code is herein scanned by the terminal of the point-of-sale, for example the terminal 105 of FIG. 1, and a request for creating an electronic vault, comprising an identifier corresponding to the obtained activation code, is transmitted to a dematerialization front-end interface (step 304), for example the dematerialization front-end interface 220 of FIG. 2, which, in turn, transmits a similar request to a dematerialization manager (step 306), For example, the dematerialization manager 225 of FIG. 2. For example, the dematerialization front-end interface and the dematerialization manager are implemented in the server 120 of FIG. 1.

If no electronic vault has been created beforehand with the same identifier, the dematerialization manager creates a new electronic vault having the received identifier and associates a “created” status therewith. A message confirming the creation of an electronic vault is then transmitted to the terminal of the point-of-sale via the dematerialization front-end interface (steps 308 and 310).

Otherwise, if an electronic vault has been created beforehand with the same identifier, an error message is transmitted to the terminal of the point-of-sale via the dematerialization front-end interface.

It should herein be observed that the use of a medium such as a physical card is one amongst the modalities for delivering the identifier to the player, to enable the creation of the vault. In other modalities, a receipt comprising the identifier is sent by electronic message (for example an SMS or an e-mail) to the player who would have indicated beforehand his/her mobile number or e-mail address.

Afterwards, the created electronic vault is herein activated in order to be able to be used, as illustrated by the set of steps 314. Using his/her personal device, for example the personal device 100-1 or 100-2 of FIG. 1, and using a game mobile application associated with a dematerialization mobile interface, for example the game mobile application 205 and the dematerialization mobile interface 210 of FIG. 2, the player addresses an activation request to the dematerialization manager via the dematerialization front-end interface (steps 316 and 318). For these purposes, the player could enter or scan the activation code printed on the medium that has been submitted or transmitted, the activation code being for example a QR code, so that this activation code is transmitted with the activation request.

In response to the reception of the request, the dematerialization manager activates the electronic vault if the latter has been created beforehand and it is in a “created” state. Its status is then modified to become “activated” and an activation confirmation message is transmitted to the personal device of the player via the dematerialization front-end interface (steps 320 and 322).

According to particular embodiments, the activation confirmation message comprises an access token, for example an access code derived from the identifier associated with the electronic vault by a predetermined mathematical function or a unique random code. This access token or access code, recorded in the personal device of the player, enables access to the electronic vault without the player having to log in. Still according to particular embodiments, an encrypted version of this access token may be displayed on the screen of the personal device of the player in the form of a code, for example in the form of a QR code, readable by a reading device to enable access to the vault from a retailer terminal.

If the electronic vault is already in an “activated” state, a message is transmitted to the personal device of the player to indicate it to him/her. If, otherwise, the electronic vault has not been created, an error message is transmitted to the personal device of the player.

Still according to particular embodiments, a personal device of a player may comprise only one access token. Consequently, if a player attempts to activate a second electronic vault from his/her personal device, the corresponding request is rejected.

Thus, an electronic vault can herein be activated on only one single personal device.

After having created and activated an electronic vault, a player could prepare his/her participation to a game, for example by creating one or more electronic coupon(s) as illustrated by the set of steps 324. For these purposes, the player could use his/her personal device and a mobile application to select or enter game or bet data and create an electronic coupon. According to particular embodiments, the player associates a unique name or label with the created electronic coupon to enable identification thereof in a list of electronic coupons.

After validation of the selected or entered data, the electronic coupon is created and transmitted, with the access token related to the electronic vault created and activated beforehand, to the dematerialization manager via the dematerialization front-end interface (steps 326 and 328). If no electronic coupon has been stored before in association with the electronic vault related to the received access token and if the vault is in an “activated” state, the received electronic coupon is stored by the game document dematerialization manager in the electronic vault related to the used access token. In particular, storage or placement of an element in an electronic vault may consist in securely storing this element, for example in a secure server controlled by the manager of the dematerialization module, in association with an identifier of the electronic vault such as the access token (or a representation of the latter).

If, otherwise, one or more electronic coupon(s) has/have been stored before in the electronic vault related to the received access token, forming a list of one or more electronic coupon(s), a test is performed to verify that the name or the label of the received electronic coupon is different from those of the electronic coupon(s) received before. If an electronic coupon received before bears the same name or label, the received electronic coupon is not stored and an error message is transmitted to the personal device of the player. Otherwise, if no electronic coupon received before bears the same name or label as the received electronic coupon, the latter is placed in the electronic vault related to the used access token (for example, it is stored in a secure server in association with an identifier of the electronic vault). A confirmation message is then transmitted to the personal device of the player via the dematerialization front-end interface (steps 330 and 332).

Using his personal device and using a game mobile application associated with a dematerialization mobile interface, the player can consult the list of his/her electronic coupons recorded in his/her electronic vault, consult the details of an electronic coupon, delete a coupon or ask for the placement of an e-coupon.

For illustration, when a player asks for the removal of an electronic coupon, a request is transmitted to the dematerialization manager via the dematerialization front-end interface to perform the operation.

Upon request from a player (step 336), a terminal of a point-of-sale may be used, by a retailer or the player himself/herself, to perform the placement of an electronic coupon, i.e. record the participation of the player to a game.

For these purposes, the access token received by the personal device of the player upon activation of the electronic vault or, preferably, an encrypted version of the latter, is displayed, for example in the form of a QR code, on the personal device of the device to be read on the terminal of the retailer. A request is then addressed to the dematerialization manager via the dematerialization front-end interface (steps 338 and 340) to obtain the list of electronic coupons recorded by the player in his/her electronic vault, with corresponding data. This list is transmitted to the terminal of the point-of-sale at the origin of the request, by the dematerialization manager via the dematerialization front-end interface (steps 342 and 344), to be displayed therein.

From this list, the player can select the electronic coupon(s) that he/she wishes to place, for example on the basis of its (their) label(s).

The terminal then adds the e-coupon in the basket of the player, in particular for the purpose of payment of the associated participation.

When the retailer confirms the payment by the player of the e-coupon basket, for each e-coupon to be placed, a request comprising the identifier of the selected electronic coupon, for example its label, and the access token received by the personal device of the player upon activation of the electronic vault (or a representation of this access token), is then addressed to the dematerialization front-end interface (step 346). In response to this request, the dematerialization front-end interface addresses a request to the dematerialization manager (step 348) to obtain complementary data of the bet. After reception of these data (step 350), the dematerialization front-end interface addresses to the game engine relating to the selected electronic coupon, a request for placing the game corresponding to these complementary bet data (step 352).

In response to this game placement request, the game engine transmits to the dematerialization front-end interface an approval message if it has been possible to place the game or a placement rejection message otherwise (step 354).

If the dematerialization front-end interface receives an approval message, it sends a request to the dematerialization manager (step 356) to create a betting electronic receipt, referring to the bet recorded in the game engine. A status associated with the electronic receipt is placed in a “placed” state. The electronic receipt and its status are stored in the electronic vault of the player.

According to particular embodiments, the dematerialization manager transmits the status and the identifier of the placed game to the payment terminal, via the dematerialization front-end interface (steps 358 and 360).

It should herein be observed that the player can place several games in the same basket.

It should also be observed that, according to particular embodiments, before payment of the basket, a retailer could individually cancel a bet included in a basket or cancel all of the bets of the basket.

According to particular embodiments, following reception of the confirmation message, the terminal prints a paper ticket which is submitted to the player. For example, this ticket may comprise the following elements or some of these elements:
an identifier of the electronic vault,
an identifier of the retailer whose terminal has been used for the placement and the payment,
the date and the time of the payment of the bet,
the total amount paid, and
for each electronic receipt,
   a short name of the game,
   an identifier of the electronic receipt, and
   the amount of the participations.

It should herein be observed that there are other means for creating electronic coupons and/or electronic receipts, in particular to facilitate the migration of the players from a traditional bet preparation and placement process into a dematerialized process. For example, the input may consist in scanning a paper coupon, dictating the data of the bet to the retailer, or selecting a game formula in which the data of the bet are randomly determined by the terminal or by the game engine.

For illustration, the following steps may be implemented:
the retailer obtains a code of the player such as the access token received following activation of an electronic vault, for example by scanning a QR code corresponding to this access token on the personal device of the player, but does not select electronic coupons in the list displayed on his/her terminal, which list could be empty,
the player submits to the retailer a paper bulletin with his/her bet data and the retailer proceeds with reading of this bulletin by the terminal,
if the terminal validates that the bulletin has been correctly filled, a request is sent to the dematerialization manager via the dematerialization front-end interface, with the game data and the obtained access token,
the dematerialization manager creates an electronic coupon and confirms recording thereof to the terminal of the retailer via the dematerialization front-end interface and
in response to reception of these data, the terminal adds the participation in the game to the basket of the player.

Afterwards, the process is identical to that described before when the bets are placed from e-coupons.

Naturally, other sequences of steps may be implemented.

According to particular embodiments, a player can use his/her personal device and a game mobile application to consult the list of electronic receipts stored in connection with the electronic vault associated with his/her device, for example to consult their status and possibly associated wins. Similarly, he/she can preferably consult the details of the game to which an electronic receipt refers, for example the data of a bet, the results of the game and the details of the wins. Still according to some particular embodiments, only the active electronic receipts, i.e. the electronic receipts that participate to upcoming draws or events, or vice versa, which have been evaluated or paid, are displayed.

As illustrated in FIG. 4 by the set of steps 400, a request may be addressed by the game mobile application implemented on a personal device of a player to the dematerialization manager, via the dematerialization front-end interface, to obtain the list of electronic receipts stored in the electronic vault associated with this electronic device (steps 402 and 404). This request comprises a code of the player such as the access token received following activation of the electronic vault (or a representation of this access token). In response, the dematerialization manager transmits the list of the electronic receipts to the game mobile application, via the dematerialization front-end interface (steps 406 and 408).

Similarly, as illustrated by the set of steps 410, a request may be addressed by the game mobile application implemented on a personal device of a player to a game engine to obtain information relating to a particular electronic receipt. For these purposes, a request comprising an electronic receipt identifier is addressed to the game engine to which the electronic receipt relates (step 412). In response to this request, information such as a participation and/or a win, are transmitted to the game mobile application (step 414).

Thus, according to the illustrated example, the list of electronic receipts is supplied by the dematerialization manager, via the dematerialization front-end interface whereas the details of a game are obtained by the mobile application by calling the game engine.

According to particular embodiments, the payment of wins from electronic receipts is performed in a point-of-sale after having obtained a payment token (set of steps 416). For these purposes, a player may use a game mobile application implemented on his/her personal device to ask for a payment token from the dematerialization front-end interface (step 418). In response, the dematerialization front-end interface transmits a payment token (step 420). The latter herein contains a code, for example a QR code, different from the code obtained upon activation of the electronic vault related to the personal device of the player, whose validity duration is limited in time (for example in the range of a few minutes). Preferably, the payment token is temporarily stored in the mobile device of the player.

To obtain the payment of wins, a player herein provides the payment token to a terminal of a point-of-sale, for example by displaying the QR code of the payment token on his/her personal device, the QR code being scanned by the terminal (step 422). After obtaining this code, the terminal addresses a verification request comprising the obtained code to the dematerialization front-end interface (step 424). If the code of the payment token is not valid or if it has expired, the payment procedure is terminated and the terminal receives a warning message (step 426). If, otherwise, the code of the payment token is valid and has not expired, the dematerialization front-end interface addresses a request to the dematerialization manager to obtain the list of electronic receipts stored in connection with the electronic vault associated with the electronic device of the player (steps 428 and 430). This request herein comprises the access token received upon activation of the electronic vault related to the personal device of the player (or a representation of this access token).

From this list, comprising for example the identifiers of the electronic receipts, the dematerialization front-end interface addresses requests to the game engines associated with these electronic receipts to obtain data such as the status of each electronic receipt, the gain and, preferably, the associated participation (step 432 and 434). Afterwards, the list of electronic receipts and these information are transmitted to the terminal of the point-of-sale at the origin of the request (step 436) so that the retailer could confirm the payment or interrupt the operation.

If the payment is confirmed by the terminal from the dematerialization front-end interface (step 438), the dematerialization front-end interface may address a new request to the dematerialization manager to obtain the list of electronic receipts stored in connection with the electronic vault associated with the electronic device of the player and then, from the list, addressing requests to the game engines associated with these electronic receipts to trigger the payments (step 440). A payment confirmation is then transmitted to the dematerialization front-end interface by each concerned game engine (step 442), these confirmations being retransmitted to the terminal (step 444).

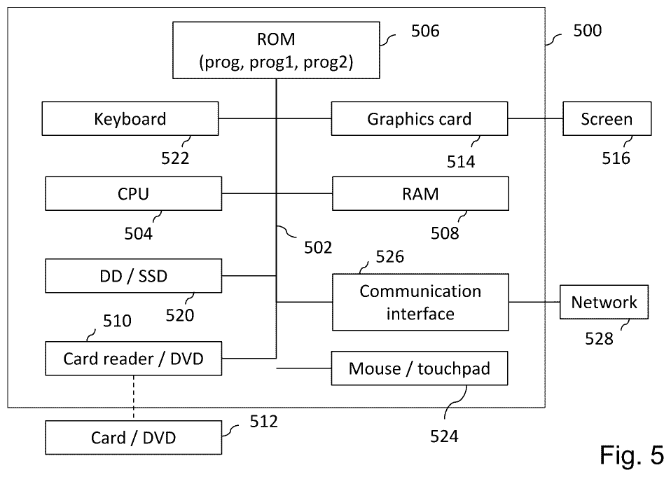

FIG. 5 illustrates an example of a device that could be used to implement, at least partially, embodiments of the invention, in particular steps described with reference to FIGS. 3 and 4.

For example, the device 500 is a personal device like the personal device 100-1 or 100-2 of FIG. 1, a terminal like the terminal 105 of FIG. 1, a server like the server 110-1, 110-2 or 120 of FIG. 1 or a computer.

Preferably, the device 500 includes a communication bus 502 to which are connected:
a central processing unit or microprocessor 504 (CPU, standing for Central Processing Unit in Anglo-Saxon terminology);
a read-only memory 506 (ROM, acronym for Read-Only Memory in Anglo-Saxon terminology) which could include the operating system and programs such as “Prog”;
a random-access memory or cache 508 (RAM, acronym for Random-Access Memory in Anglo-Saxon terminology) including registers adapted to record variables and parameters created and modified during the execution of the aforementioned programs, and
a communication interface 526 connected to a distributed communication network 528, for example a wireless communication network and/or a local-area communication network, the interface being able to transmit and receive data, in particular towards and from a device of a user.

Optionally, the device 500 may also be fitted with the following elements:
a storage unit 520 of the SSD (standing for Solid State Drive in Anglo-Saxon terminology) type or of the hard disk type which could comprise the aforementioned programs “Prog” and data processed or to be processed according to the invention;
a physical or tactile keyboard 522 and a mouse 524 or any other pointing device like an optical pen, a touchscreen or a remote control enabling the user to interact with the programs according to the invention;
a reader 510 of a removable storage medium 512 such as a memory card or a disk, for example a DVD disk; and
a graphics card 514 connected to a screen 516.

The communication bus enables communication and interoperability between the different elements included in the device 500 or connected thereto. The representation of the bus is not restrictive and, in particular, the central unit could communicate instructions to any element of the device 500 directly or via another element of the device 500.

The executable code of each program enabling the programmable apparatus to implement the processes according to the invention may be stored, for example, in the hard disk 520 or in a read-only memory 506.

According to one variant, the executable code of the programs could be received via the communication network 528, via the interface 526, to be stored identically as described before.

More generally, the program(s) could be loaded into one of the storage means of the device 500 before being executed.

The central unit 504 will control and direct the execution of the instructions or portions of software code of the program(s) according to the invention, which instructions are stored in the hard disk 520 or in the read-only memory 506 or in the aforementioned other storage elements. Upon start-up, the program(s) that is/are stored in a non-volatile memory, for example the hard disk 520 or the read-only memory 506, is/are transferred into the random-access memory 508 which then contains the executable code of the program(s) according to the invention, as well as registers for storing the variables and parameters necessary for the implementation of the invention.

Depending on the considered embodiment, some acts, actions, events or functions of each of the methods described in the present document may be performed or occur according to an order different from that in which they have been described, or may be added, merged or not performed or not occur, as the case may be. Furthermore, in some embodiments, some acts, actions or events are performed or occur concurrently rather than successively.

Although described through some detailed embodiments, the proposed method and the equipment for implementing the method comprise different variants, modifications and improvements which will become obvious to a person skilled in the art, it being understood that these different variants, modifications and improvements are within the scope of the invention, as defined by the following claims. In addition, different aspects and features described hereinabove may be implemented together, or separately, or substituted with one another, and all of the different combinations and sub-combinations of the aspects and features are within the scope of the invention. Furthermore, it is possible that some systems and equipment described hereinabove do not incorporate all of the modules and functions described for the preferred embodiments.

1. A method for dematerializing game receipts, comprising the following steps, implemented by a game receipt dematerialization module of a processor-based server:
creating an electronic vault and associating the electronic vault with a personal device of a player;
recording at least one electronic coupon in the electronic vault, upon request from the personal device of the player, an electronic coupon comprising data of a bet to be placed on a game managed by a game engine;
according to a list of said at least one electronic coupon recorded in the electronic vault, placing at least one bet with at least one game engine; and
receiving, from each game engine with which a bet has been placed, a message confirming the placement of said bet and recording an electronic receipt in the electronic vault.

2. The dematerialization method according to claim 1, further comprising the following steps, implemented by the dematerialization module:
obtaining, from each game engine associated with each electronic receipt recorded in the electronic vault, win data associated with the electronic receipt;
in case of winning, transmitting the win data to a point-of-sale application;
receiving a confirmation from the point-of-sale application; and
obtaining payment of the win from the game engine.

3. The dematerialization method according to claim 2, further comprising the following steps, implemented by the dematerialization module:
managing a status associated with each stored electronic receipt; and
in case of winning, changing the corresponding status.

4. The dematerialization method according to claim 3, further comprising the following steps, implemented by the dematerialization module:
in case of winning, generating a temporary payment code;
transmitting the generated temporary payment code to the personal device, the temporary payment code comprising the win data; and
receiving a request to change said status from the point-of-sale application.

5. The dematerialization method according to claim 1, according to which each electronic receipt is recorded in the electronic vault in association with an electronic vault access code associated with the personal device of the player.

6. The dematerialization method according to claim 5, wherein each electronic coupon is recorded in the electronic vault in association with the electronic vault access code associated with the personal device of the player.

7. The dematerialization method according to claim 5, further comprising the following steps, implemented by the dematerialization module:
generating the electronic vault access code in response to a request for activation received from a point-of-sale application; and
transmitting the electronic vault access code to the personal device.

8. The dematerialization method according to claim 5, further comprising the following step, implemented by the personal device:
displaying the electronic vault access code, for example in the form of a QR code, said electronic vault access code allowing reading thereof by a point-of-sale application.

9. A dematerialization module, configured to implement the method according to claim 1.

10. A gaming system, comprising a dematerialization module and a personal device of a player, configured to implement the method of claim 1.

11. A computer program recorded on a non-transitory media executable by a processor, comprising instructions for implementing each of the steps of the method according to claim 1.
